(19) United States
(12) Patent Application Publication
(10) Pub. No.: US 2009/0051372 A1
(43) Pub. Date: Feb. 26, 2009

(54) 3D fluid confined sample stream coulter flow cytometry

(76) Inventors: Palaniappan Sethu, Louisville, KY (US); Cindy K. Harnett, Louisville, KY (US)

Correspondence Address: GREER, BURNS & CRAIN, 300 S WACKER DR, 25TH FLOOR, CHICAGO, IL, 60606, US

(21) Appl. No.: 11/978,323

(22) Filed: Oct. 29, 2007

Related U.S. Application Data
(60) Provisional application No. 60/855,056, filed on Oct. 30, 2006.

(51) Int. Cl. G01N 27/02

(52) U.S. Cl. 324/693

(57) ABSTRACT

A microfluidic flow cytometry device includes a substrate and transverse electrodes formed on the substrate. An elastomer microfluidic focusing channel system formed on the substrate focuses a sample stream onto the floor of an outlet channel that is substantially wider and taller than cells or particles of interest and that has the transverse electrodes disposed in its floor upstream of an exit site. A step in the outlet channel upstream of the transverse electrodes vertically confines sample stream flow onto the floor of the outlet channel over the transverse electrodes. Buffer inlet channels introduce a buffer stream for horizontal focusing of the sample stream into the central region of the outlet channel at the transverse electrodes. A sample inlet channel is smaller in vertical height than the buffer inlet channels for introducing a sample stream such that the buffer vertically focuses the sample stream away from the top of the outlet channel. Sensitivity of detection is good enough to conduct both qualitative and quantitative analysis. Detection and analysis circuitry can be optimized to conduct analyze real and imaginary impedance at frequencies optimized toward tagged particles and or cells, and assays are possible.

### PRIORITY CLAIM

Applicants claim priority benefits under 35 U.S.C. § 119 on the basis of Patent Application No. 60/855,056, filed Oct. 30, 2006.

### FIELD

A field of the invention is flow cytometry.

### BACKGROUND

Flow cytometry, a technique for counting, analyzing and sorting cells or particles suspended in a stream, is used in a variety of applications from fundamental biological research to drug development for diseases such as HIV and cancer. However, current cytometry devices are confined to clinical and laboratory settings due to their size, expense, power requirements and need for skilled personnel. Flow cytometry devices are optically based and require the sophisticated, bulky, and expensive equipment associated with optical detection and analysis.

One complexity associated with optical detection flow cytometry concerns the optical data that is generated by the technique. The optical data typically includes scatter plots and histograms. Interpretation of this data is complicated, requiring skilled personnel and/or sophisticated analysis system

There have been a few attempts to develop a portable flow cytometry devices, but these efforts typically focus on miniaturization of the flow cell. Optical detection is still used. Optical detection generally requires an excitation source, signal detectors and photon multipliers for signal amplification along with trained experts to analyze and interpret the obtained data. These devices remain, accordingly, bulky and expensive.

Optical detection flow cytometry remains in favor despite its expense, complexity, and inconvenience because it has several advantages over other cell interrogation techniques. It provides both quantitative (counts) and qualitative information (physical and biochemical measurements) using light scattering and cell associated fluorescence. It also possesses the ability to rapidly measure complex multi-parameter data from heterogeneous mixtures of cells, setting it apart from microscopy and bulk biochemical measurement techniques. For these reasons, optical detection flow cytometry devices are widely used in universities, medical schools, pharmaceutical companies and diagnostics laboratories.

Portable technologies have advantages over optical detection flow cytometry, but portable technologies fail to provide the detection and analysis capabilities of optical detection flow cytometry. Samples for many types of analysis require immediate processing and therefore cannot be analyzed by optical detection flow cytometry unless the sample is collected at the location of the flow cytometry device.

Electrical impedance-based sensing, known as the Coulter technique, has been proposed as being miniaturized. Using this approach, a cell or particle sample is suspended in a conductive solution, causing a spike in resistance between the electrodes when a low-conductivity object interrupts the electrical path. Nanoscale particles have been detected using this approach when the minimum channel dimensions are comparable to the particle size. However, this technique is only applicable to extremely well characterized and filtered sample solutions containing particles slightly smaller than the channel width. Very small channel widths lead to the problems concerning blockage of the channel.

Two-dimensional hydrodynamic focusing has previously been combined with the micro-Coulter counter technique to conduct simple particle counting operation. See, e.g., Rodriguez-Trujillo et al, (Low Cost Micro-Coulter Counter with Hydrodynamic Focusing,” Microfluidics and Nanofluidics 3, 171-176 (2007). In the Rodriguez-Trujillo device, two buffer streams on each side of the sample were used to achieve a two dimensionally focused stream with a minimum width of 2 microns in a device that could be fabricated through molding techniques. This approach puts the particle in the middle of a thin sheet of electrolyte, leaving conductive paths above and below the particle. Consequently, the channel depth still limits sensitivity. Other efforts to achieve three dimensional focusing in miniaturized optical detection systems have used complex structures that require alignment steps during fabrication, which are difficult to achieve in practice. See, Simmonet et al., “High-Throughput and High-Resolution Flow Cytometry in Molded Microfluidic Devices,” Analytical Chemistry 78, 5653-63 (2006)

Electrical resistance (coulter) detection in cytometry remains limited to quantitative analysis, due to the fact that sensitivity remains insufficient for qualitative analyses including, for example, cell identification. Cell identification requires that a developed signal be sufficiently sensitive to distinguish differences in the properties of cells and/or markers/tags attached to particular cells.

### SUMMARY OF THE INVENTION

An embodiment of the invention is a microfluidic flow cytometry device includes a substrate and transverse electrodes formed on the substrate. An elastomer microfluidic focusing channel system formed on the substrate focuses a sample stream onto the floor of an outlet channel that is substantially wider and taller than cells or particles of interest and that has the transverse electrodes disposed in its floor upstream of an exit site. A step in the outlet channel upstream of the transverse electrodes vertically confines sample stream flow onto the floor of the outlet channel over the transverse electrodes. Buffer inlet channels introduce a buffer stream for horizontal focusing of the sample stream into the central region of the outlet channel at the transverse electrodes. A sample inlet channel is smaller in vertical height than the buffer inlet channels for introducing a sample stream such that the buffer vertically focuses the sample stream away from the top of the outlet channel. Sensitivity of detection is good enough to conduct both qualitative and quantitative analysis. Detection and analysis circuitry can be optimized to analyze real and imaginary impedance at frequencies optimized toward tagged particles and/or cells, and assays are possible.

### BRIEF DESCRIPTION OF THE DRAWINGS

FIGS. 1A and 1B are schematic diagrams illustrating hydrodynamic confinement cytometers used in testing to compare to the FIG. 1C preferred embodiment flow cytometer;

FIG. 1C is a schematic diagram showing a preferred embodiment 3D hydrodynamically confined molded microchannel flow cytometer device;

FIG. 2 illustrates impedance analysis for tagged sample cells according to an embodiment of the invention;

FIGS. 3A-3C are additional partial schematic plan, side cross-section and end cross-section views of the FIG. 1C device of the invention illustrating channel structure and three-dimensional microfluidic focusing;

FIGS. 4A-4D illustrate the structure and flows of a portion of a preferred embodiment molded elastomer flow cytometer device; and

FIGS. 5A-5D illustrate testing results of a preferred embodiment device (device 3).

### DETAILED DESCRIPTION OF THE PREFERRED EMBODIMENTS

The invention provides quantitative and/or qualitative flow cytometry in a miniaturized three dimensional hydrodynamically focused micro fluidic device with an elastomer structure that can be readily fabricated by straightforward molding techniques. A sample stream in a device of the invention is confined in both the horizontal and vertical directions, and guided across sensing electrodes disposed transversely on the floor of a wide channel. Sensitivity surpasses two dimensional hydrodynamically confined microfluidic Coulter counters, while all channel dimensions in devices of the invention are substantially greater than the particle diameter. Vertical focusing is accomplished with a two-level design in micro channels, while the shape of the channels readily permits molding in a single cast elastomer piece.

A microfluidic flow cytometry device of an embodiment of the invention includes a substrate and transverse electrodes formed on the substrate. An elastomer microfluidic focusing channel system formed on the substrate focuses a sample stream onto the floor of an outlet channel that is substantially wider and taller than cells or particles of interest and that has the transverse electrodes disposed in its floor upstream of an exit site. A step in the outlet channel upstream of the transverse electrodes vertically confines sample stream flow onto the floor of the outlet channel over the transverse electrodes. Buffer inlet channels introduce a buffer stream for horizontal focusing of the sample stream into the central region of the outlet channel at the transverse electrodes. A sample inlet channel is smaller in vertical height than the buffer inlet channels for introducing a sample stream such that the buffer vertically focuses the sample stream away from the top of the outlet channel. Sensitivity of detection is good enough to conduct both qualitative and quantitative analysis. Detection and analysis circuitry can be optimized to conduct analyze real and imaginary impedance at frequencies optimized toward tagged particles and or cells, and assays are possible.

In operation of a preferred embodiment, a sample stream enters only on the bottom layer of the elastomer, while low-conductivity buffer enters from a channel that is both wider and taller than the sample stream. Both streams are injected into a low outlet channel of equal height and width to the sample inlet stream. Low-conductivity buffer forms a sheath around the top and sides of the outlet channel, forcing the sample into a narrow stream at the bottom of the channel adjacent to electrodes disposed across the bottom of the outlet channel. Because the two-level mold's features can be captured in one cast elastomer piece, a single layer of elastomer can accomplish three-dimensional focusing. Minimal alignment (+/−2 mm) is required to position the elastomer channel over a pair of thin-film metal electrodes on a substrate, e.g., a glass substrate. Fabrication can be achieved with a single cast elastomer piece, and is less complicated than other techniques that require assembly of many layers of elastomer, or back-side wafer etching and alignment.

Embodiments of the invention provide a portable microfluidic flow cytometer and cytometry methods that uses impedance-based detection to discriminate between different cells and pathogens. By using the Coulter principle along with commercially available immuno-modified beads that serve to amplify differences in particle conductivity, devices and methods of the invention, due to the high sensitivity provided, generate complex multi-parameter data from heterogeneous cell populations. Assays similar to conventional flow cytometry that rely on light scattering and binding of fluorescently labeled antibodies (cell or pathogen surface markers and intracellular markers) can be obtained with simple electrical resistance detection, and an output can be processed to deliver a simple positive or negative readout. Through use of immuno-modified conductive/non-conductive tags that bind to specific cell surfaces and intracellular markers, the electrical resistance of cells can be modified and complex multi-parameter data can then be obtained from heterogeneous cell populations similar to assays routinely performed using conventional flow cytometry. Embodiments of the invention provide a portable cytometer that can be inexpensive enough for use in field applications. Cytometers of the invention can be integrated as part of a lab-on-a-chip. Construction and packaging of preferred devices is rugged, portable, and ideal for use in resource limited settings.

Preferred embodiments will now be discussed with respect to the drawings. The drawings include schematic figures that are not to scale, which will be fully understood by skilled artisans with reference to the accompanying description. Features may be exaggerated for purposes of illustration. From the preferred embodiments, artisans will recognize additional features and broader aspects of the invention.

Referring to FIGS., 1A-1C, a cytometry device of the invention 10 (device 3) is illustrated along with comparison test devices 1A and 1B (devices 1 and 2). The cytometry device 10 of the invention includes transverse electrodes 11 in the floor of an outlet microchannel 12 that is formed in an elastomer material on top of substrate 13, which can be, e.g., a glass or plastic substrate, or a portion of a lab on a chip circuit. A step 14 upstream of the channel provides for vertical focusing of a sample stream 16 by a buffer stream. Buffer inlet microchannels 18 provide a path flow for horizontal focusing of the sample stream. A sample inlet microchannel 20 is smaller in vertical height than the buffer inlet microchannels such that the buffer vertically focuses the sample stream. The buffer inlet microchannels 18 are at a non-parallel angle to the sample inlet microchannel to achieve the horizontal flow. The step 14 provides further vertical focusing to keep the sample stream 16 in a small vertical and horizontal cross section in the substantially wider and taller outlet microchannel 12. Devices 1 and 2, on the other hand, are test devices that lack vertical focusing. Respective buffer and sample injection sites 22 and 24 accommodate syringe pumps or other injection mechanisms for injecting buffer and sample streams, and an exit site 25 permits removal of the sample and buffer streams after detection.

The transverse electrodes 11 are connected to a detection circuit 26 that detects changes in resistance cause by the presence of specific particles or cells in the sample stream. The device 10 and devices of the invention generally are based on the Coulter principle, which states that particles pulled through an orifice, concurrent with an electrical current, produce a change in impedance that is proportional to the size of the particle traversing the orifice. In devices of the invention, instead of an orifice, a wide and tall outlet microchannel channel 12 is used, and the three dimensional hydrodynamic focusing brings the sample stream into a small cross section over the transverse electrodes 11. The channels in the device 10 can be molded in a single cast elastomer piece via a two-level mold over a substrate than includes the electrodes 11 on its surface.

The impedance of a circuit element is defined as the ratio of the phasor voltage across the element to the phasor current through the element (1) where Z_{R} is the electrical impedance, Vᵣ is the phasor voltage and Iᵣ is the phasor current through the element. In addition to quantitative analysis, the device 10 of has a sensitivity that permits qualitative analysis Significant modifications to the cellular resistance can be achieved by coupling cells with both conductive and non-conductive beads, for example, and the vertical and horizontal focusing brings the sample stream into a small cross section over the electrodes 11 and multi-parameter data can be obtained from heterogeneous cell populations when resistance modifying tags are applied to alter cellular resistance. This is comparable to optical detection qualitative cytometry, but is achieved with an inexpensive and small portable device 10 of the invention using electrical resistance as the detection mechanism.

Using different combinations of conductive and non-conductive micro/nano-scale beads/particles with different sizes, specific markers can be attached to both the cell surface and intra-cellularly; thereby to creating a unique impedance signature which can be detected by the electrodes due to the sensitivity provided by the small cross-section vertically and horizontally focused sample stream brought into contact with the electrodes 11. Based on the resistance of a cell passing over the electrodes, a unique signal is generated. This signal does not need major processing or analysis and can be read-out, for example, using simple on-chip signal processing.

The vertically and horizontally focused sample stream and electrode arrangement eliminates variability associated with the position of cells in the z-direction as they pass over the electrodes. Cells are kept proximate to the floor of the outlet microchannel 12 and the transverse electrodes 11 such that the same cells or cell/marker combinations will reliable produce a highly precise signal strength. Impedance values between 100 ohms and 10 M ohms can be measured, at a set frequency or over a user-defined frequency sweep. The detection circuit 26 returns real and imaginary parts of the impedance at each frequency, in two separate serial data streams to an analysis circuit 32. The detection and analysis circuits 26 and 32, of course, can be a single integrated circuit, separate modules, implemented in software, firmware, etc. Circuit, as used here, simply identifies the function to be accomplished and is not dependent upon any particular hardware, software, or firmware arrangement.

The real part of the data provides information about the resistive characteristics, while the imaginary part provides information on the capacitive charging and magnetic properties of the particle/cell over a range of frequencies. The detection and analysis circuits 26 and 32 integrated circuit replaces several desktop instruments, enabling extreme miniaturization and cost savings.

The focused sample stream flows over the electrodes 11. Conductivities of the sample and buffer streams are selected to maximize the signal-to-background level of impedance measurements as cells pass over the electrodes 11. The buffer streams are high-conductivity liquid that provide a low electrical resistance path, e.g., approximately 200 ohms per 50-micron wide side stream when a 50 micron channel depth is used with 100 S/m conductivity buffer. The liquid of the sample stream has a higher electrical resistance; e.g., 2000 ohms across a 10-micron wide channel containing 2 S/m conductivity blood plasma. Therefore, when a high conductivity cell passes through, it creates a sudden drop in electrical resistance across the central stream that is detected by an impedance-monitoring circuit as a cell count.

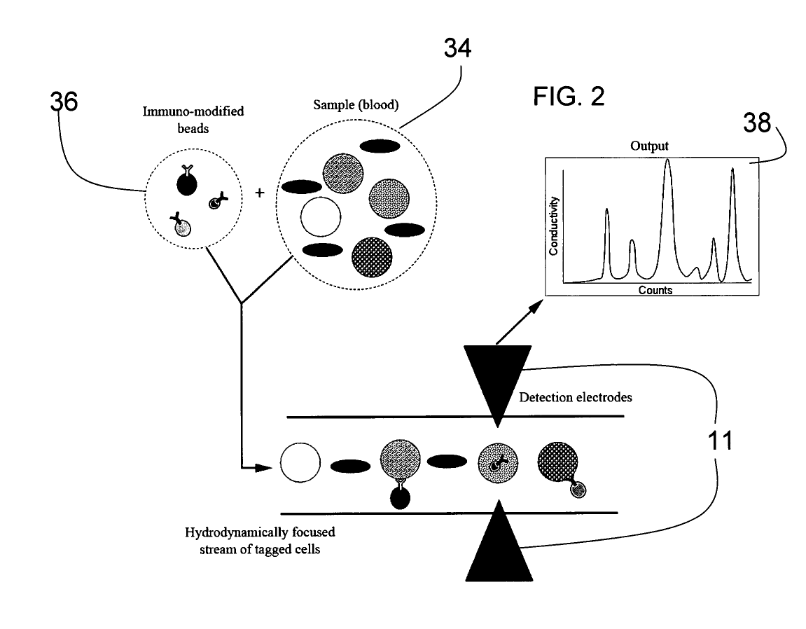

FIG. 2 illustrates, schematically, a resistance tagged detection system of the invention. A blood sample 34 is interacted with immuno-modified beads 36 having an affinity for a cell of interest and sent into the device 10 within a high conductivity sample stream, which is focused vertically and horizontally by the buffer stream over the electrodes 11. The detection system provides a real output 38 including conductivity counts, and also outputs the imaginary output, as discussed above. The detection provides detailed information regarding the expression of cell surface and intracellular markers using an antibody-based approach. Conventional optical detection flow cytometry collects this information from heterogeneous cell populations by using antibodies conjugated to fluorophores with different excitation and emission wavelengths. Using impedance measurements to discriminate between different cell types and expression of surface markers uses immuno-modified tags that can alter the electrical resistance of cells. Time-multiplexed immunoassays can then be conducted by dividing a heterogeneous cell sample into batches which are incubated with the same type of conductive bead, modified with a different immuno tag in each batch. The batches are then flowed sequentially through the device for counting.

Qualitative analysis can also be conducted, but requires more sophisticated data analysis to be able to perform a number of tasks: distinguishing cells which display multiple target molecules from those only displaying one; taking advantage of the diversity in the sizes (50 nm-1 μm), materials (polystyrene, polycarbonate, latex, iron, nickel, carbon, etc.) and properties (varying levels of conductivity, capacitance, and magnetic moment) to modify the frequency-dependent complex impedance of individual cells; and recognizing distinct impedance profiles with each measurement representing a unique combination of the presence or absence of the multiple target molecules. Processing algorithms, such as Kalman filtering, can be applied as PC or microcontroller software in the analysis circuit 32 to identify several different conductivity signatures.

A repertoire of beads of different sizes and materials analogous to currently available fluorophores with varying excitation and emission wavelengths can be used. Commonly used and extensively characterized beads can be used. Commercially available beads for magnetic activated cell sorting or MACS (Miltenyi Biotec, Auburn, Calif.) are suitable for cytometry in accordance with the invention. These beads are electrically conductive and readily available conjugated with a wide variety of antibodies targeting cell surface markers. Spherotech Inc. (Libertyville, Ill.) is a supplier of uncoated and avidin/biotin coated polymer, silica and ferromagnetic beads, that can also be used. Duke Scientific Co. (Fremont, Calif.) is also supplies a wide range of avidin/biotin coated and uncoated polymer, glass, silica, latex and metal particles that can be used. Another supplier in the micro/nano bead area is Bangs Laboratories (Fishers, Ind.), which specializes in the supply of coated and uncoated polymer, metal, latex, silica, glass and several magnetic and supramagnetic micro and nano spheres. The diversity of beads in terms of size, material and conductivity (or insulation) will allow us to develop complex assays yielding distinct impedance signatures for detection and diagnosis.

Tagging of cells can be accomplished. A preferred process for tagging beads first prepares the beads. Beads are initially suspended in solution, e.g., a 4% (v/v) solution of 3-mercaptopropyl trimethoxysilane in ethanol and then incubated for a period of time, e.g., 3-4 hours. Following this silanization process the beads are then removed using centrifugation and re-suspended in another solution, e.g., a solution containing 50 mg of GMBS (N-y-maleimidobutyryloxy succinimide ester) dissolved in 50 ml of Dimethyl sulfoxide (DMSO), sodium azide, lyophilized bovine serum albumin (BSA) for another 3 hours. Cells are then removed using centrifugation and incubated with lyophilized NeutrAvidin a and restored with distilled water at a concentration of 50 mg/ml and incubated for 2 hours. This is then followed by incubation with specific biotinylated antibodies. This basic protocol achieves surface modification and has been shown to be successful for a wide range of materials from polymers to metals. vFor different materials: concentrations, incubation times, temperature, pH etc need to be varied and optimal conditions for surface modification will be determined. Other surface modification approaches can also be used, and may be necessary in certain cases. Following functionalization of beads with antibodies, cell populations are labeled by incubation at concentrations corresponding to the distribution of antigens on the cell surface with gentle agitation for a period of time to achieve labeling, e.g., 45 minutes. Other labeling techniques are also suitable for flow cytometry in accordance with the invention, and some preferred techniques will be discussed. Generally, any tags or labels that can achieve a detectable modified impedance are suitable for use with the invention. Some example techniques will be discussed.

Nanoparticles for Intracellular Labeling

Conventional optical detection flow cytometry uses using fluorescent tagged antibodies targeted against intracellular molecules, but gold and other nanoparticles that produce a fluorescence change can also produce a measurable impedance change and can be used to conduct flow cytometry in accordance with the invention. For example, commercially available NANOGOLD® particles are small enough to diffuse into fixed, permeablized cells and can be used with the invention. A single NANOGOLD® particle contains a maleimide functional group incorporated into a ligand on its surface that has a specific reactivity towards sulfhydryl groups, and may be covalently linked to reduced disulfides in the hinge region of antibodies. Apart from antibodies, molecules that can be labeled using gold particles include proteins, peptides, and oligonucleotides (typically molecules with accessible sulphydryl groups).

Tagging of intracellular targets with immuno-modified NANOGOLD® or other nanoparticles can be used to achieve a change in the cellular resistance that can be detected with the a cytometer of the invention. This enables intracellular interrogation in addition to cell surface marker determination.

Fixation and Permeablization

Techniques known as the paraformaldehyde-methanol (PF/M) method and the paraformaldehyde-Tween 20 (PF/T) method can be used. Fixed and permeabilized cells can be washed and incubated for various lengths of time with a saturating amount of each antibody coupled nano particle.

Size and Shape Based Cell Discrimination

The shape and size of cells produce different impedance responses that can be distinguished by a cytometer of the invention. Different voltages and frequencies can be optimized for detection that best allows for discrimination of different cell types.

Phenotype Determination

MOLT-3 and RAJI cells exhibit much of the same characteristics of peripheral blood T and B cells. MOLT-3 phenotype is characterized by the expression ˜97% of cells expressing CD5 and CD7 and ˜60% of the cells expressing of CD1 and CD4. CD5 and CD7 can be used as reliable phenotype markers. RAJI cells on the other hand are characterized by expression of CD19. Both cell lines express CD45 and are negative for CD34. Using combinations of beads with varying levels of conductance, one can obtain distinct impedance signatures that can be used identify each cell type from of mixture of MOLT-3 cells, RAJI cells and NIH 3T3 fibroblasts in a cytometer of the invention.

Assays with Positive or Negative Results

Assays that produce simple positive and negative results can be conducted with cytometry according to the invention. Activation of MOLT-3 and RAJI cells with bacterial antigens like LPS, superantigens like SEB induce expression of early activation cell surface markers like CD30, CD69 and CD70 and expression of intracellular cytokines like IL-1β, IL-2, IL-10 and TNF-α. Detection of intracellular markers requires fixation and permeablization of the cells, which can be achieved by several techniques, such as Paraformaldehyde (PFA)-Tween and PFA-Methanol. Using a combination of phenotype and activation markers conjugated to beads with different properties assays can be created for detection of specific conditions with a positive or negative result yielding different impedance signatures in cytometer of the invention

Information regarding expression of phenotype and signaling molecules can be obtained by altering the resistance of cells by attachment of immuno-modified conductive/non-conductive beads. A diverse library of beads that vary in size and their levels of conductivity enables assays that use a combination of beads to produce distinct impedance profiles.

Experimental Prototypes and Experimental Results

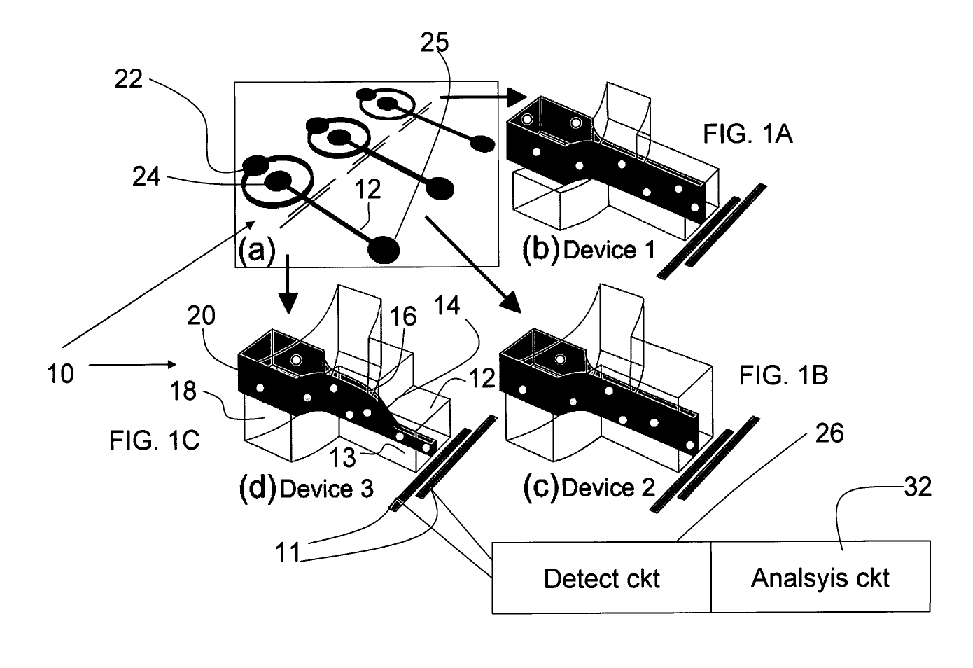

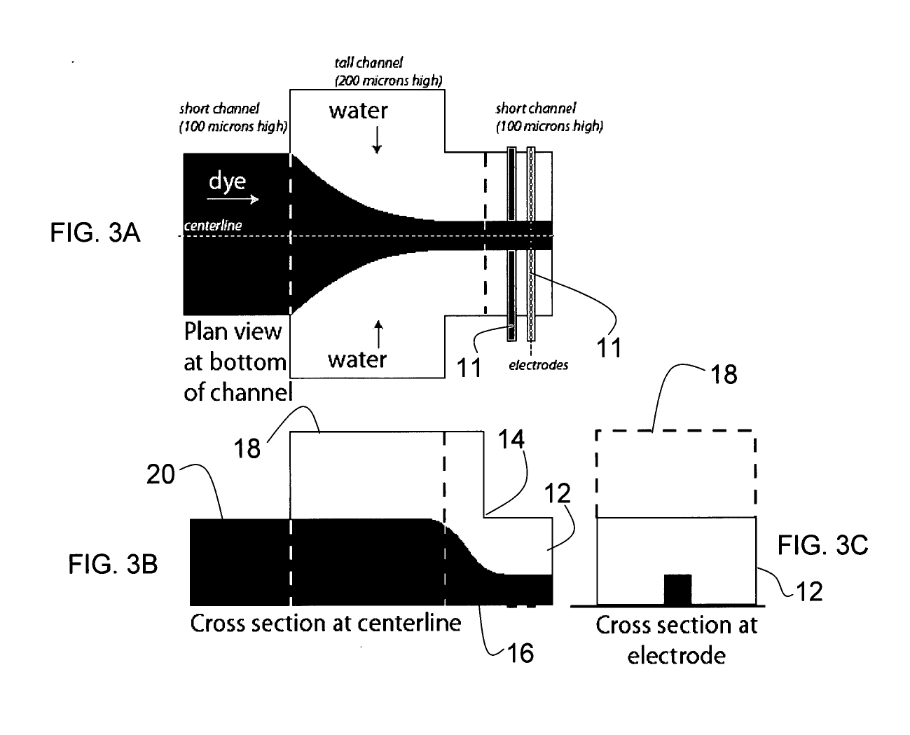

Experimental devices of the invention as shown in FIG. 1C (device 3) were fabricated. The devices shown in FIGS. 1A and 1B (device 1) and (device 2) were also fabricated for comparison testing. FIGS. 3A-3C illustrate additional views of the focusing features of the device 10 shown in FIG. 1C as fabricated for comparison testing. Dimensions shown in FIGS. 3A-3C are exemplary dimensions of a preferred embodiment experimental device that was tested using dye as a sample stream and water as a buffer stream. The dye (sample) stream and buffer (water) stream are shown and labeled in FIGS. 3A-3C. The focusing brings the sample stream onto the floor of the outlet channel 12 over the transverse electrodes 11 in a vertically and horizontally focused cross section that is substantially narrower and shorter than the outlet channel 12.

The devices were fabricated by casting silicone elastomer on a two-level mold made from SU-8 negative photoresist (MicroChem, Newton, Mass., USA), and sealing the elastomer replicas to glass wafers that had been patterned with thin-film metal electrodes.

Photomasks obtained from Fineline Imaging (Colorado Springs, Colo., USA) were produced with a 25,400 DPI resolution laser plotter. This rapid and relatively inexpensive process enabled optimization of the microfluidic design through three different device layouts (FIGS. 1A-1C). The minimum feature size of these masks was approximately 10 um.

Designs consisted of a single layer control device (“Device 1”,), a two-level device that produces a particle stream of half the outlet channel height (“Device 2,”), and a two-level device with a stepped outlet for full 3-D focusing (“Device 3,”). Devices 2 and 3 each required two separate masks. All features in the first mask were fabricated in the lower layer of SU-8 closest to the substrate. Features in the second mask were fabricated in both the lower and upper layers of SU-8, resulting in features approximately twice as tall as those in the lower layer.

During fabrication, the first layer of SU-8 50 was spun for 30 seconds at 1500 rpm, then solvent-removal baked on a hotplate which ramped the temperature to 95 C. for 15 minutes. The resist was then exposed to UV light through the first photomask. Exposure was followed by a hotplate bake at 65 C. for 2.5 minutes, then 95 C. for 7 minutes, which cured the features in the exposed areas without removing unexposed resist, leaving a planar surface for further processing. The second layer of SU-8 was then applied and soft baked as above. The second mask was aligned with the visible cured features in the lower layer, exposed, and post-exposure baked as above. All unexposed resist was then removed in propylene glycol monomethyl ether acetate. Consequently, the sample inlet and other features only in the first layer are roughly half of the height of the two-layer inlets and channels. In the test devices, the height of the first layer is approximately 90 microns while the height of both layers combined is about 200 microns. The width of the channels was 100 microns, which is sufficient to minimize the risk of clogging.

The finished SU-8 mold was hardened by flood-exposure to UV light at approximately double the previous exposure dose, increasing its durability for multiple replication cycles. Microfluidic channels were replicated by casting polydimethylsiloxane (PDMS) elastomer (Sylgard 184, Dow Corning Corporation) over the mold.

Thin film electrodes, with a typical edge-to-edge spacing of 25 microns, were patterned on a Pyrex wafer (Corning glass type 7740) using common photolithography techniques. A 25-50 nm thick titanium adhesion layer was applied in a sputter deposition system, followed by a 200 nm thick layer of platinum. Ti—Pt electrodes resist electrochemical corrosion and are biocompatible. The glass substrate is also biocompatible. Its low conductivity improves the sensitivity of the device by minimizing the leakage current.

The PDMS was subsequently adhered to the patterned Pyrex wafer using a plasma activation and heat treatment process. After the Pyrex wafer was rinsed with water and dried under a stream of laboratory air, both Pyrex and PDMS bonding surfaces were treated in an air plasma cleaner (Harrick Plasma, Ithaca N.Y., USA) at 30 W and approximately 100 mTorr for 30 seconds. The PDMS and Pyrex surfaces were then aligned and pressed together, and the devices were baked in an oven at 85° C. overnight, resulting in an irreversible and fluid-tight bond.

Wires were attached to the electrode bond pads using CircuitWorks CW2400 conductive epoxy. Tygon tubing was press-fitted into holes punched in the ports of the device, producing a liquid-tight connection. Fluids were introduced from a syringe pump or gravity-driven reservoir. Side streams were supplied through one inlet port using a symmetrical T-junction on the wafer, which reduced the number of external connections and produced nearly identical flow rates on either side of the center stream.

Fluorescent polystyrene microbeads were used in the experiments as a low-conductivity particle with well-characterized diameter and good visibility in fluorescence microscopy. To prevent the beads from settling to the bottom of the fluid reservoirs, the sample was suspended in a density-matched aqueous sucrose solution (1 g sucrose per 6.5 mL, 1.05 g/cm³). Because this solution was essentially nonconductive, the sucrose solution in the center stream was formulated with 1 mM potassium chloride (KCl), raising its conductivity to 147 uS/cm. Two particle sizes were tested, representing the large and small ends of the size range for typical mammalian cells. Large particles were polystyrene 20-micron diameter yellow-green fluorescent particles (Bangs Labs, Inc., product FS07F) and small particles were 6-micron diameter yellow-green fluorescent beads (Fluoresbrite Carboxy YG Microspheres, Polysciences, Inc #18141). To match viscosity, the outer streams were composed of the same density sucrose solution, but in deionized water rather than KCl.

A lock-in amplifier (SRS830, Stanford Research Systems) supplied a constant-amplitude sine wave across the electrodes and monitored the current, outputting the result as an analog voltage directly proportional to the conductance between the electrodes. The applied signal had a typical peak-to-peak amplitude of 1V and frequency of 30-50 KHz. A computer data acquisition signal sampled the lock-in output at 20 KHz, producing a time series of relative conductance values as particles flowed past the electrodes.

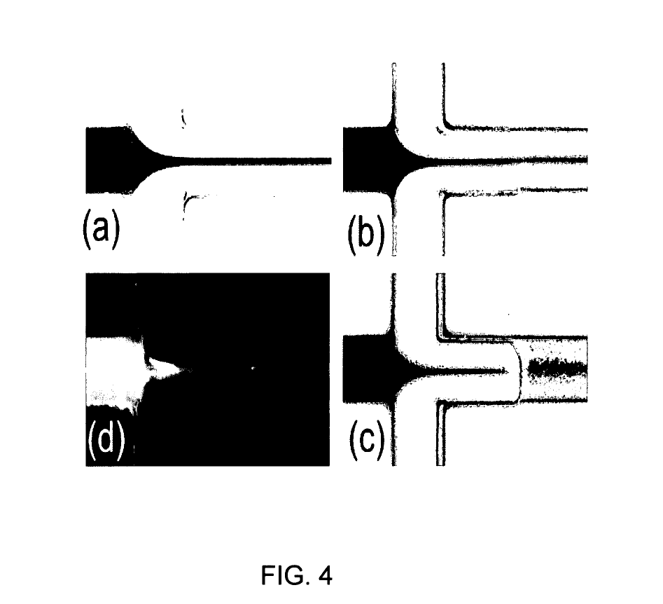

Confocal microscopy was performed to verify the location of the central stream in the two-level devices. FIG. 4A is a top view of Device 2, with 5 uM Texas Red dye in sucrose solution pumped at 0.2 microliters/minute, and with side-streams of undyed sucrose solution each flowing at 1 microliter/minute. This image was collected at approximately the halfway point in the device, 90 microns above the Pyrex substrate. Here, and at points below, it closely resembles the flow pattern seen in Device 1. Above 90 microns, however, the dye stream fades out, indicating that dye is excluded from the top of the device as shown in FIG. 1C. FIG. 4B shows the dye stream at the level of the Pyrex substrate in Device 3 under similar flow conditions. In contrast, FIG. 4C shows the flow in Device 3 at a height of 90 microns. The dye stream enters the device as usual, but when it encounters the step down to the lower level, undyed liquid pushes the dye stream down out of the focal plane, indicating that three-dimensional hydrodynamic focusing has been achieved.

FIG. 4D is a fluorescence micrograph showing hydrodynamic focusing of 6-micron fluorescent beads in 5 uM Texas Red sucrose solution. During the 140 ms shutter time, fast-moving beads in the focused stream appear as streaks, while individual slow-moving beads are visible in the entry channel.

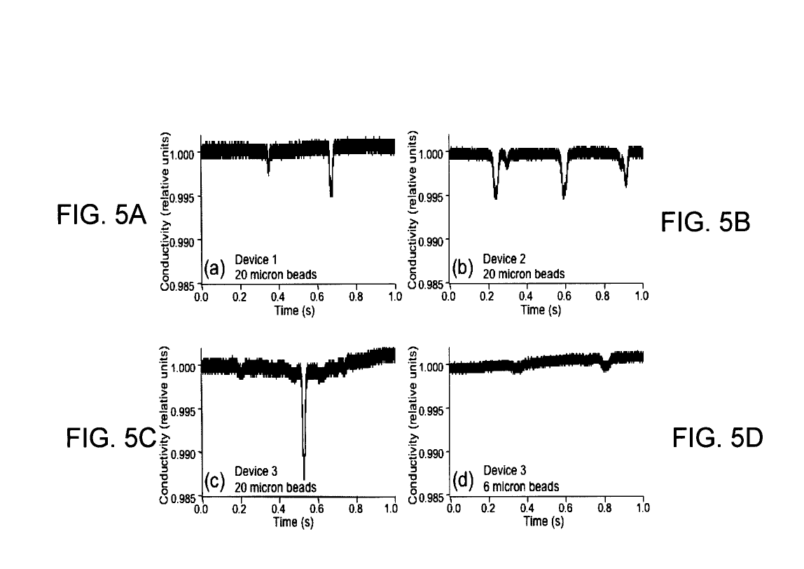

FIG. 5A shows a plot of the relative conductivity versus time for 20 micron beads in Device 1, the 2-D hydrodynamically focused device. Flow rates were kept low in these experiments (in the range of 1 microliter/minute for fluid in each side stream, 0.1 microliters/minute for the central stream) to enable visual confirmation of beads entering the detection channel. In FIG. 5A, the baseline conductivity, assigned the value 1, drops by as much as 0.5% while the bead is between the electrodes. Smaller drops are attributed to beads moving in streamlines higher above the electrodes. Such beads interrupt a smaller percentage of the current, and typically have a faster transit time, as expected. FIG. 5B shows similar results for 20 micron beads in Device 2. Both Devices 1 and 2 produce a similar profile for the central stream.

FIG. 5C shows a 1.25% decrease in conductivity as a mixture of 6-micron diameter and 20 micron-diameter beads pass through Device 3. The sharp drop in conductivity is attributed to a 20 micron bead observed entering the device during data collection, while new small fluctuations are attributed to the 6-micron beads, which were not observable in Devices 1 and 2. FIG. 5D shows a 0.2% conductivity decrease when 6-micron beads alone are flowed through the device. The modified 3-D hydrodynamic focusing device produces substantially greater changes in conductivity than the other test devices.

Sorting can also be accomplished by applying an electric field (electrophoresis), a magnetic field (magnetophoresis) to cells tagged with magnetic particles, or a pressure pulse to drive a single cell type down a separate channel.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A microfluidic flow cytometry device, comprising:
a substrate;
transverse electrodes formed on the substrate;
an elastomer microfluidic focusing channel system formed on said substrate, including,
an outlet channel substantially wider and taller than cells or particles of interest and having the transverse electrodes disposed in a floor of said outlet channel upstream of an exit site;
a step in said outlet channel upstream of said transverse electrodes to vertically confine sample stream flow onto the floor of said outlet channel over said transverse electrodes;
buffer inlet channels to introduce a buffer stream for horizontal focusing of a sample stream into a central region of said outlet channel at said transverse electrodes; and
a sample inlet channel smaller in vertical height than the buffer inlet channels for introducing a sample stream such that the buffer vertically focuses the sample stream away from the top of said outlet channel.

2. The device of claim 1, further comprising detection and analysis circuitry that detects and analyzes changes in impedance of fluid passing over said transverse electrodes.

3. The device of claim 2, wherein said detection and analysis circuitry analyzes real and imaginary parts of impedance for a frequency and voltage.

4. The device of claim 3, wherein said detection and analysis circuitry analyzes real and imaginary parts of impedance at one or more voltages or frequencies optimized for detection and characterization of cells or particles of interest.

5. The device of claim 3, wherein said detection and analysis circuitry analyzes real and imaginary parts of impedance at one or more voltages or frequencies optimized for detection and characterization of tagged cells or particles of interest.

6. The device of claim 1, wherein said elastomer microfluidic focusing channel system is configured such that its features can be captured in one cast elastomer piece by a two-level mold.

7. The device of claim 1, wherein said elastomer microfluidic focusing channel system comprises a single cast elastomer piece.

8. A method for flow cytometry in a mircofluidic device, the method comprising steps of:
vertically and horizontally focusing a sample stream over transverse electrodes in the floor in a central portion of a microchannel and in a cross section that is substantially smaller than the microchannel;
detecting impedance changes with the transverse electrodes;
analyzing the impedance changes to identify a cell or particle of interest.

9. The method of claim 8, further comprising a step of tagging cells or particles of interest, wherein said analyzing distinguishes tagged cells.

10. The method of claim 8, wherein said step of analyzing comprises analyzing real and imaginary impedance at one or more voltages and frequencies.
